(19) United States
(12) Patent Application Publication
(10) Pub. No.: US 2014/0374015 A1
(43) Pub. Date: Dec. 25, 2014

(54) PIN MOUNT BONDING METHODS AND ARTICLES

(71) Applicant: 3M INNOVATIVE PROPERTIES COMPANY, St. Paul, MN (US)

(72) Inventor: Dmitriy Salnikov, Woodbury, MN (US)

(21) Appl. No.: 14/369,326

(22) PCT Filed: Dec. 26, 2012
(86) PCT No.: PCT/US2012/071655

§ 371 Date: Jun. 27, 2014

Related U.S. Application Data
(60) Provisional application No. 61/581,393, filed on Dec. 29, 2011.

(51) Int. Cl. F16B 19/00; B32B 37/16; B32B 37/12

(52) U.S. Cl. CPC F16B 19/00; B32B 37/1284; B32B 37/16; B32B 37/1292; B32B 2037/1253; B32B 2310/0831
USPC 156/275.5; 411/500

(57) ABSTRACT

Articles and methods are presented that are useful in mounting pins or studs on substrates such as composite materials. An anchor according to the present invention comprises a stud attached to a base, where the base is substantially UV-transparent, and optionally a UV-curable adhesive, a pressure sensitive adhesive, an adhesive that is both UV-curable and pressure sensitive, or some combination of the above.

### FIELD OF THE DISCLOSURE

This disclosure relates to articles and methods useful in mounting pins or studs on substrates such as composite materials.

### SUMMARY OF THE DISCLOSURE

Briefly, the present disclosure provides an anchor for application of a stud to a substrate comprising a stud attached to a base, where the base is substantially UV-transparent. In some embodiments, the base may bear a UV-curable adhesive. In some embodiments, the UV-curable adhesive is a liquid. In some embodiments, the UV-curable adhesive is a solid or gel. In some embodiments, the base bears a pressure sensitive adhesive. In some embodiments, the pressure sensitive adhesive is patterned in a ring. In some embodiments, the pressure sensitive adhesive is patterned in a C-shaped arc. In some embodiments, the base bears a pressure sensitive adhesive and a UV-curable adhesive. In some embodiments, the base bears a pressure sensitive adhesive which is a UV-curable adhesive.

In another aspect, the present disclosure provides methods for applying a stud to a substrate. In one embodiment the method comprises the steps of: a) providing an anchor comprising a stud attached to a base, where the base is substantially UV-transparent; b) applying a UV-curable adhesive to the base; c) applying the anchor to a substrate; and d) curing the UV-curable adhesive by application of UV light. In some such embodiments step b) proceeds step c). In some such embodiments step c) proceeds step b). In one embodiment the method comprises the steps of: a) providing an anchor comprising a stud attached to a base, where the base is substantially UV-transparent, and where the base bears a UV-curable adhesive; b) applying the anchor to a substrate; and c) curing the UV-curable adhesive by application of UV light. In one embodiment the method comprises the steps of: a) providing an anchor comprising a stud attached to a base, where the base is substantially UV-transparent, and where the base bears a pressure sensitive adhesive; b) applying a UV-curable adhesive to the base; c) applying the anchor to a substrate; and d) curing the UV-curable adhesive by application of UV light. In some such embodiments step b) proceeds step c). In some such embodiments step c) proceeds step b). In some embodiments where step c) proceeds step b), the pressure sensitive adhesive is patterned in a C-shaped arc. In one embodiment the method comprises the steps of: a) providing an anchor comprising a stud attached to a base, where the base is substantially UV-transparent, and where the base bears a pressure sensitive adhesive which is UV-curable adhesive; b) applying the anchor to a substrate; and c) curing the UV-curable adhesive by application of UV light.

### BRIEF DESCRIPTION OF THE DRAWING

FIG. 1 depicts an anchor according to the present disclosure.

### DETAILED DESCRIPTION

The present disclosure provides a faster bonding, more robust adhesive for attachment of threaded or bare pins or studs to substrates such as composite or metal materials. In some embodiments the adhesives according to the present disclosure exhibit fast cure, require minimal amount of surface preparation, and require minimal tooling.

In another aspect, this invention describes the method and materials to construct an anchor comprising a UV-transparent composite base and a threaded or bare pin or stud.

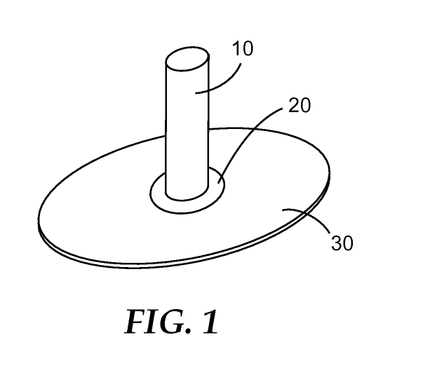

With reference to FIG. 1, an anchor according to the present disclosure comprises a threaded or bare stud 10, attached to a UV-transparent base 30. The stability of the attachment of stud 10 to base 30 may be augmented by the inclusion of optional washer 20. Stud 10 and washer 20 may be of any suitable material, including metals and engineering plastics such as polyamide, PTFE, PPO, PEEK, and the like. Base 30 may be of any suitable material which is substantially UV-transparent. As used herein, substantially UV-transparent means sufficiently UV-transparent to allow

UV cure of materials situated under the base.

In some embodiments, the anchor additionally comprises a UV-curable adhesive (not shown) on the back surface of base 30, i.e., the surface opposite stud 10. In some embodiments, the UV-curable adhesive is liquid. In some such embodiments the adhesive may be applied to the anchor prior to positioning on a substrate and the adhesive then cured by use of a UV light source. In some embodiments, the UV-curable adhesive is a gel or solid. In some such embodiments the adhesive may be applied to the anchor prior to positioning on a substrate and the adhesive then cured by use of a UV light source. In other of such embodiments the anchor may be supplied with adhesive attached, optionally covered to prevent premature cure. The anchor may be positioned on a substrate and the adhesive then cured by use of a UV light source.

In some embodiments, the anchor additionally comprises a pressure sensitive adhesive (not shown) on the back surface of base 30, i.e., the surface opposite stud 10. In some such embodiments an additional UV-curable adhesive may be applied to the anchor prior to positioning on a substrate and the adhesive then cured by use of a UV light source. In some such embodiments, the pressure sensitive adhesive may be applied on the outer edge of the back surface so as to form a ring. In some such embodiments an additional UV-curable adhesive may be applied to the anchor prior to positioning on a substrate and the adhesive then cured by use of a UV light source. In particular, the UV-curable adhesive may be applied to the anchor within the ring. In some such embodiments, the pressure sensitive adhesive may be applied on the outer edge of the back surface except for a gap, so as to form a C-shaped arc. In some such embodiments an additional UV-curable adhesive may be applied to the anchor prior to positioning on a substrate and the adhesive then cured by use of a UV light source. In particular, the UV-curable adhesive may be applied to the anchor within the C-shaped arc. Alternately, the anchor may be applied to the substrate and thereafter a liquid UV-curable adhesive may be applied to the anchor within the C-shaped arc by injection through the opening or gap of the C-shaped arc. In such an embodiment, the anchor may be applied to the substrate with the gap of the C-shaped arc oriented upward.

In some embodiments, the anchor additionally comprises a pressure sensitive adhesive (not shown) on the back surface of base 30, i.e., the surface opposite stud 10, where the pressure sensitive adhesive is also a UV-curable adhesive. In some such embodiments the anchor may be positioned on a substrate and the adhesive then cured to full strength by use of a UV light source.

Any suitable adhesives may be used, including adhesives demonstrated in the examples below and adhesives analogous to those demonstrated in the examples below. Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Sigma-Aldrich Company, St. Louis, Mo., or may be synthesized by known methods. Unless otherwise reported, all ratios are by weight percent.

The following abbreviations are used to describe the examples:
° F.: degrees Fahrenheit
° C.: degrees Centigrade
cm: centimeters
kPa: kilopascals
inches Hg: inches of mercury
mm: millimeters
μm: micrometers
UV: ultraviolet

### Fabrication of Carbon Fiber Composite Substrates.

Peel ply protected surfaces, type “BMS 8-255, TYPE I, CLASS 2, STYLE 3K-70-PW” prepreg fabric, were laid up and cured in accordance with BAC5317-4.

### Fabrication of Threaded Pin and Stud Composite Base (“Anchor”).

### Anchor Example 1

The head of a #8-32 corrosion resistant steel self-clinching flush head stud was placed over a nominally 2 inch (5.08 cm) diameter one-ply fiberglass epoxy prepreg, available under the trade designation “FIBERITE MXB 7701-7781” from Cytec Industries, Inc., Woodland Park, N.J. A hole, slightly larger than the #8-32 stud, was cut out of two plies of the same fiberglass prepreg material. The two plies of prepreg were then placed over the stud and pressed into intimate contact with the underlying single ply prepreg, enveloping the head of the fastener between the plies. A #8 corrosion resistant steel washer was placed over the stud, against the two plies of prepreg. A plastic pipe cap was filled with a vinyl polysiloxane impression material, obtained under the trade designation “7301-HB EXPRESS LOW VISCOSITY IMPRESSION MATERIAL” from 3M Company, St. Paul, Minn., and the cap secured over the stud. The stud assembly was then placed inside a vacuum bag and a vacuum of nominally 25 inches of Hg (84.6 kPa) applied. The bag was sealed then cured in an autoclave at 120° C. for 90 minutes at 45 psi (310.3 kPa). After cooling, the prepreg plies were trimmed to approximately 1.5 inch (3.81 cm) diameter and the cap removed from the stud. The underside of the prepreg ply was then sanded with a 100-grit sandpaper and wiped with a isopropyl alcohol prior to bonding.

### Anchor Example 2

The general procedure for fabricating Anchor Example 1 was repeated, wherein a polyester peel ply, type “BMS 8-308 TYPE III”, obtained from Precision Fabrics Company, Greensboro, N.C., was used under the prepreg base. The polyester peel ply was removed just prior to bonding the anchor to the carbon fiber composite substrate, and without any additional surface preparation steps.

### Adhesives.

DP-100: A clear two-part epoxy adhesive, available under the trade designation “SCOTCH-WELD DP100 TWO PART CLEAR EPDXY ADHESIVE” from 3M Company, St. Paul, Minn.

DP 460: A two-part epoxy adhesive, available under the trade designation “SCOTCH-WELD DP460 TWO PART EPDXY ADHESIVE” from 3M Company.

DP-807: A two-part acrylic adhesive, available under the trade designation “SCOTCH-WELD DP807 TWO PART ACRYLIC ADHESIVE” from 3M Company.

SBT-9214: A 0.51-inch (13 mm) structural bonding tape, available under the trade designation “STRUCTURAL BONDING TAPE 9214” from 3M Company.

VHB-4618: A double coated general purpose white acrylic foam tape, available under the trade designation “VHB TAPE 4618”.

LC-1214: A one-component UV-curable medium-high viscosity adhesive, available under the trade designation “LIGHT CURE ADHESIVE LC-1214” from 3M Company.

### Comparative A

DP-100 was applied to the underside of a threaded composite base anchor, which was then manually pressed onto the carbon fiber composite substrate and cured at 75° F. (23.9° C.) for 24 hours.

### Comparatives B-C

The procedure generally described in Comparative A was repeated, wherein the DP-100 was substituted with DP-460 and DP-807, representing Comparatives B and C, respectively.

### Example 1

One liner was removed from a nominally 2 inch (5.08 cm) diameter disc of SBT-9214 tape and adhered to the underside of the threaded composite base anchor. The opposing liner was then removed from the tape and the base of the threaded composite base anchor then adhered to the composite substrate. The threaded composite base anchor was then exposed to UV light for 120 seconds at an approximate distance of 5 mm using a model “UV CURING LAMP 2500” from 3M Company.

### Example 2

The general procedure described in Example 1 was repeated, wherein the SBT-9214 tape was first applied to the composite substrate, and then the underside of the threaded composite base anchor was pressed onto the tape.

### Example 3

A section of VHB-4618 tape was trimmed to a “C” shaped arc having an approximately 330 degree circumference, with an outer diameter of 1.5 inches (3.81 cm) and an inner diameter of approximately 1.25 inches (3.12 cm). One liner was removed from the tape and the tape adhered to the underside of an anchor. The opposing liner was then removed from the tape, after which the anchor was manually pressed onto the carbon fiber composite substrate. LC-1214 was then injected into the gap between the anchor and the substrate via the space in the “C” shaped arc. The assembly was cured with a 30 second exposure to the UV curing lamp at an approximate distance of 5 mm.

### Example 4

DP-100 was applied to the underside of a threaded composite base anchor, which was then manually pressed onto the carbon fiber composite substrate and cured with a 30 second exposure to the UV curing lamp at an approximate distance of 5 mm.

Curing conditions and time to achieve green strength and full strength adhesion of the Comparatives and Examples are summarized in Table 1.

TABLE 1

| | | Time To Achieve | Time To Achieve |
|---|---|---|---|
| Example | Curing Conditions | “Green” Strength | Full Strength |
| Comparative A | 75° F. for 24 hours | 1 hour | 24 hours |
| Comparative B | 75° F. for 24 hours | 5 minutes | ≧4 hours |
| Comparative C | 75° F. for 24 hours | 10 minutes | ≧2 hours |
| Example 1 | UV exposure for 120 seconds | 2 hours | 24 hours |
| Example 2 | UV exposure for 120 seconds | 2 hours | 24 hours |
| Example 3 | UV exposure for 30 seconds | Immediately after | Immediately after |
| | | exposure | exposure |
| Example 4 | UV exposure for 30 seconds | Immediately after | Immediately after |
| | | exposure | exposure |

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. An anchor for application of a stud to a substrate comprising a stud attached to a base, where the base is substantially UV-transparent.

2. The anchor according to claim 1 wherein said base bears a UV-curable adhesive.

3. The anchor according to claim 2 wherein said UV-curable adhesive is a liquid.

4. The anchor according to claim 2 wherein said UV-curable adhesive is a solid or gel.

5. The anchor according to claim 1 wherein said base bears a pressure sensitive adhesive.

6. The anchor according to claim 5 wherein said pressure sensitive adhesive is patterned in a ring.

7. The anchor according to claim 5 wherein said pressure sensitive adhesive is patterned in a C-shaped arc.

8. The anchor according to claim 1 wherein said base bears a pressure sensitive adhesive and a UV-curable adhesive.

9. The anchor according to claim 8 wherein said pressure sensitive adhesive is patterned in a ring.

10. The anchor according to claim 1 wherein said base bears a pressure sensitive adhesive which is a UV-curable adhesive.

11. A method for applying a stud to a substrate comprising:
a) providing an anchor comprising a stud attached to a base, where the base is substantially UV-transparent;
b) applying a UV-curable adhesive to the base;
c) applying the anchor to a substrate; and
d) curing the UV-curable adhesive by application of UV light.

12. The method according to claim 11 wherein step b) proceeds step c).

13. The method according to claim 11 wherein step c) proceeds step b).

14. A method for applying a stud to a substrate comprising:
a) providing an anchor comprising a stud attached to a base, where the base is substantially UV-transparent, and where the base bears a UV-curable adhesive;
b) applying the anchor to a substrate; and
c) curing the UV-curable adhesive by application of UV light.

15. A method for applying a stud to a substrate comprising:
a) providing an anchor comprising a stud attached to a base, where the base is substantially UV-transparent, and where the base bears a pressure sensitive adhesive;
b) applying a UV-curable adhesive to the base;
c) applying the anchor to a substrate; and
d) curing the UV-curable adhesive by application of UV light.

16. The method according to claim 15 wherein step b) proceeds step c).

17. The method according to claim 15 wherein step c) proceeds step b).

18. The method according to claim 17 wherein said pressure sensitive adhesive is patterned in a C-shaped arc.

19. A method for applying a stud to a substrate comprising:
a) providing an anchor comprising a stud attached to a base, where the base is substantially UV-transparent, and where the base bears a pressure sensitive adhesive which is UV-curable adhesive;
b) applying the anchor to a substrate; and
c) curing the UV-curable adhesive by application of UV light.
